(19) United States
(12) Patent Application Publication
(10) Pub. No.: US 2006/0290657 A1
(43) Pub. Date: Dec. 28, 2006

(54) Multi-instruction transverse input device

(75) Inventor: Chin-Wen Chou, Taipei Hsien (TW)

Correspondence Address: BIRCH STEWART KOLASCH & BIRCH, PO BOX 747, FALLS CHURCH, VA, 22040-0747, US

(73) Assignee: Zippy Technology Corp.

(21) Appl. No.: 11/182,836

(22) Filed: Jul. 18, 2005

Related U.S. Application Data
(63) Continuation-in-part of application No. 11/165,125, filed on Jun. 24, 2005.

(51) Int. Cl. G09G 5/00

(52) U.S. Cl. 345/156

(57) ABSTRACT

A multi-instruction transverse input device includes a hand-control unit and two anchor members located on two sides of the hand-control unit to generate instruction signals. The hand-control unit is mounted onto a base. Each anchor member includes a leg coupler which contains a plurality of legs. The hand-control unit is held on the base and movable transversely so that when it is moved leftwards or rightwards by user's hands, a first conductive element is compressed to form an electric connection on the leg coupler on each side. Thereby the screen picture is moved transversely. The invention is compact and simply structured, and can be fabricated and assembled easily.

This application is a continuation-in-part, and claims priority, of from U.S. patent application Ser. No. 11/165,125 filed on Jun. 24, 2005, entitled “Input device including a multi-direction type scroll wheel”

### FIELD OF THE INVENTION

The present invention relates to an input device and particularly to a multi-instruction input device movable transversely to issue instructions.

### BACKGROUND OF THE INVENTION

Conventional electronic devices such as mouse, keyboards or remote controllers, besides having left and right function keys to facilitate operation of document browsing, Web searching and image zooming or the like, usually have a wheel between the left and right function keys to directly perform page or line scrolling function without users depressing Page Down key on the keyboard or moving the mouse pointer to the longitudinal scroll bar on the right side and depressing the left key to make reading of a lengthy text or document easier.

However, these days many documents have a greater width which often exceeds the width of the screen, especially some data tables used in EXCEL or ACCESS applications. As the table fields could be very long, users have to move the mouse pointer to the transverse scroll bar on the lower side of the screen to move the screen picture leftwards and rightwards to browse the entire text of the document. Such an operation is time-consuming. This is especially burdensome on some small screens or to users who have weak eye sight.

To solve this problem, U.S. Patent Publication No. 2003/0025673A1 discloses a wheel input device that can scroll images in multiple directions. Referring to FIG. 1, it includes a hand-control unit 100 mounting onto a frame 110. The hand-control unit 100 is a turnable wheel held by an axle 120 on a holding member 130. The hand-control unit 100 can be tilted leftwards and rightwards about the axle 120. The holding member 130 has a switch 140 respectively on the left side and the right side. The switch 140 has a contact area 150. The frame 110 has a contact arm 160 extended outwards from each of two sides that does not connect to the contact area 150 in normal conditions. Users can roll the hand-control unit 100 forwards and backwards to issue a longitudinal page scroll instruction. In addition, users can also move the hand-control unit 100 leftwards and rightwards to make the contact arm 160 to connect the contact area 150 to issue a signal through the switch 140 thereby to scroll the screen picture leftwards or rightwards. Hence through one hand-control unit 100, the screen picture can be scrolled longitudinally and transversely. Operation is much easier.

However, the construction for the hand-control unit 100 needs the frame 110, the axle 120 and the holding member 130. They are complicated and bulky. Fabrication and assembly are difficult. Moreover, the hand-control unit 100 has to rely on the button switch 140 to issue signals. The cost is higher, and the size is bigger. The electronic device adopted such an input device is difficult to shrink the size.

### SUMMARY OF THE INVENTION

Therefore the primary object of the present invention is to provide a multi-instruction transverse input device that has a hand-control unit movable transversely to output leftward and rightward instructions.

In order to achieve the foregoing object, one embodiment of the invention includes a hand-control unit and two anchor members located on two sides of the hand-control unit to generate instruction signals. The hand-control unit is mounted onto a base and movable transversely. Each of the anchor members has a leg coupler. The hand-control unit has a guiding portion which drives a controller to generate a transverse movement corresponding to the hand-control unit. When users move the hand-control unit leftwards or rightwards, the controller is driven to depress a first conductive element to connect to the leg coupler on each side to generate an instruction signal for moving leftward or rightward.

According to another embodiment of the invention, the anchor member which contains the leg coupler and the first conductive element are adopted on a hand-control unit that is movable transversely relative to a base to replace the conventional button switch so that the transverse scroll function can still be achieved, but the total size can be shrunk and the structure is simpler.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional wheel input device.

FIG. 2 is a perspective view of an embodiment of the multi-instruction transverse input device of the present invention.

FIG. 3 is an exploded view of an embodiment of the multi-instruction transverse input device of the present invention.

FIGS. 4A and 4B are schematic views of an embodiment of the multi-instruction transverse input device of the present invention in operating conditions.

FIG. 5 is an exploded view of another embodiment of the multi-instruction transverse input device of the present invention.

FIG. 6 is an exploded view of yet another embodiment of the multi-instruction transverse input device of the present invention.

FIG. 7 is a schematic view of an embodiment of the present invention adopted for use on a mouse device.

FIG. 8 is a schematic view of an embodiment of the present invention adopted for use on a keyboard.

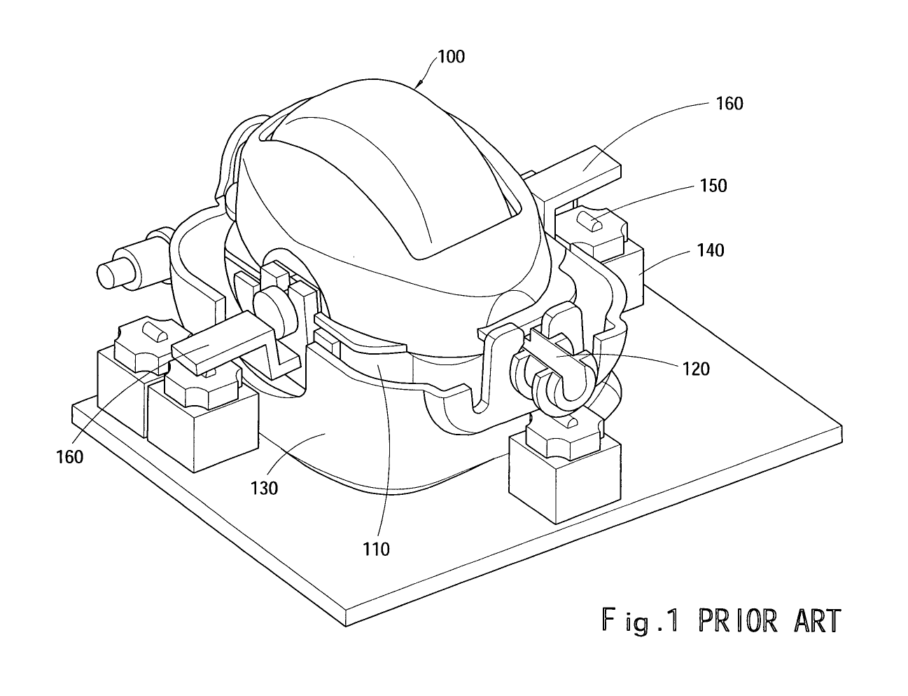

### DETAILED DESCRIPTION OF THE PREFERRED EMBODIMENTS

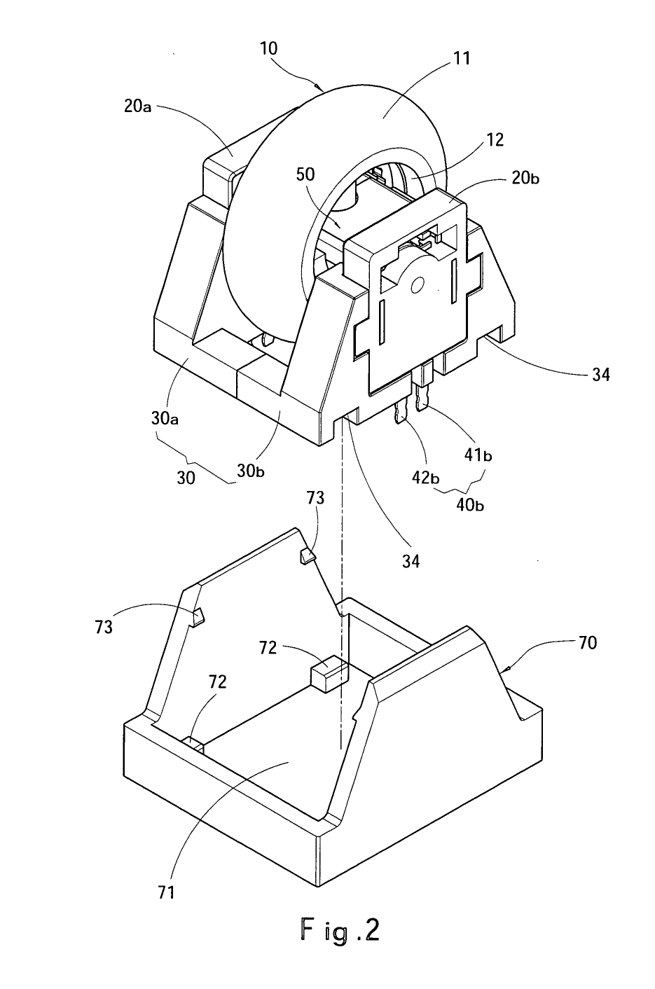

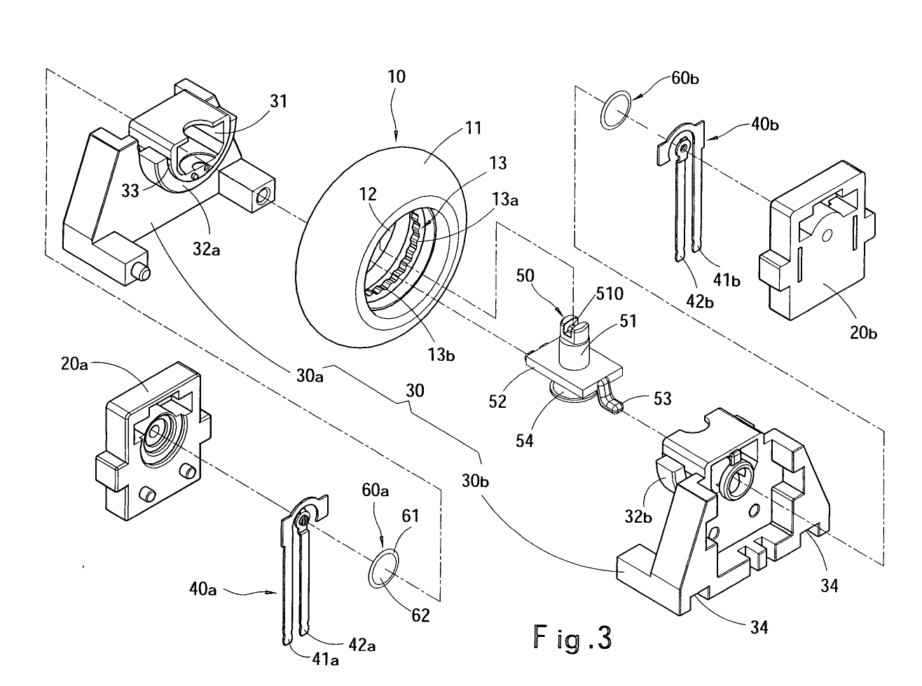

Please refer to FIGS. 2 and 3 for an embodiment of the multi-instruction transverse input device of the invention. It includes a hand-control unit 10 and two anchor members 20a and 20b on two sides of the hand-control unit 10 to generate instruction signals.

The hand-control unit 10 is mounted onto a base 30 and is movable transversely. The hand-control unit 10 is a disk-like wheel, or a cylinder or the like to match electronic products that can be moved transversely to touch the anchor members 20a and 20b and generate the instruction signals. The drawings serve only illustrative purpose and are not the limitation of the invention. The base 30 consists of two base elements 30a and 30b.

The anchor members 20a and 20b are located on two sides of the hand-control unit 10 and have respectively leg couplers 40a and 40b. The leg couplers 40a and 40b are embedded integrally in the anchor members 20a and 20b by injection forming without separating. The leg couplers 40a and 40b have a plurality of legs. In this embodiment, there are first legs 41a and 41b, and second legs 42a and 42b.

The base 30 has a housing chamber 31 on an upper side to hold a controller 50 which is movable with the transverse movement of the hand-control unit 10 to generate the instruction signals to move a screen picture leftwards and rightwards. To achieve the aforesaid object, the hand-control unit 10 includes an exterior portion 11 to receive a force and a hollow mounting portion 12 driven by the exterior portion 11 to move synchronously. The hollow mounting portion 12 contains a guiding portion 13 which includes a plurality of consecutive guiding elements 13a and guiding notches 13b that are spaced from one another alternately. The controller 50 is installed on the hollow mounting portion 12, and includes a bottom seat 52, a moving rod 51 mounting onto the bottom seat 52, two lugs 53 extended from two sides of the bottom seat 52, and a first elastic element 54 located beneath the bottom seat 52. The moving rod 51 has a boss 510 on an upper side. In normal conditions, the boss 510 is latched on one of the guiding notches 13b. Thereby the hand-control unit 10 can drive the controller 50 to move synchronously leftwards and rightwards. The lugs 53 mate the leg couplers 40a and 40b to generate instructions. The first elastic element 54 aims to anchor the controller 50 in the housing chamber 31.

According to the embodiment of the invention, two first conductive elements 60a and 60b are provided to connect to the leg couplers 40a and 40b to form a circuit. The first conductive elements 60a and 60b are located between the lugs 53 of the controller 50 and the leg couplers 40a and 40b, and are positioned above the first legs 41a and 41b, and movable transversely relative to the lugs 53 and generate a compression feeling on user's hand. The first conductive elements 60a and 60b are elastic dome-shaped blades and each has a flat peripheral rim 61 and a bulged portion 62 in the center. Operation details will be discussed later.

After the hand-control unit 10 and the anchor members 20a and 20b have been assembled, the assembly of the anchor members 20a and 20b, and the base elements 30a and 30b are encased in a holding dock 70. The holding dock 70 has a hollow portion 71 to allow the leg couplers 40a and 40b to be extended outwards. The holding dock 70 has a plurality of first latch elements 72 and second latch elements 73 to couple with wedge portions 34 formed on the base 30 and the upper side of the base 30 to hold the multi-instruction transverse input device securely.

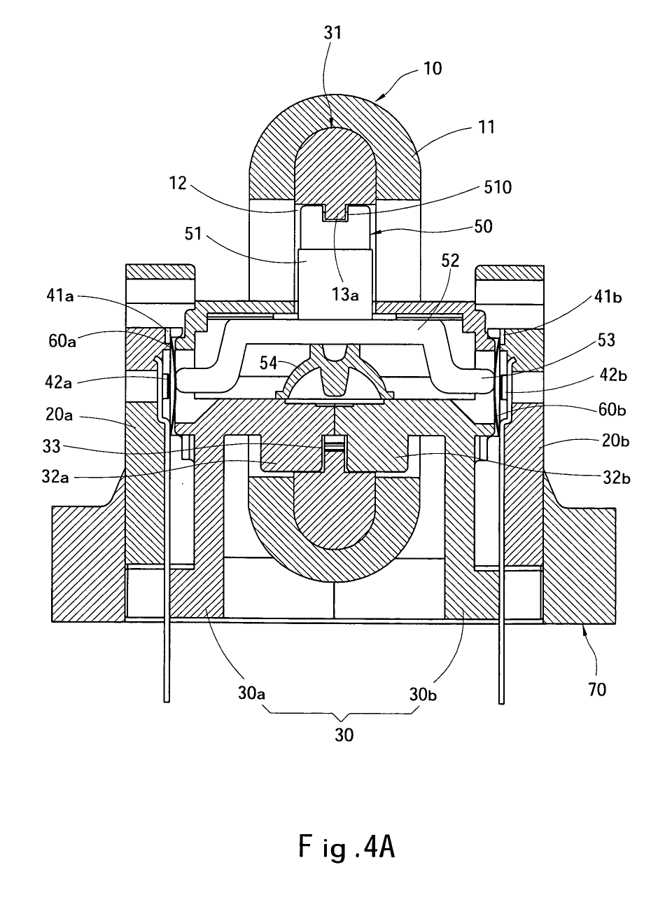

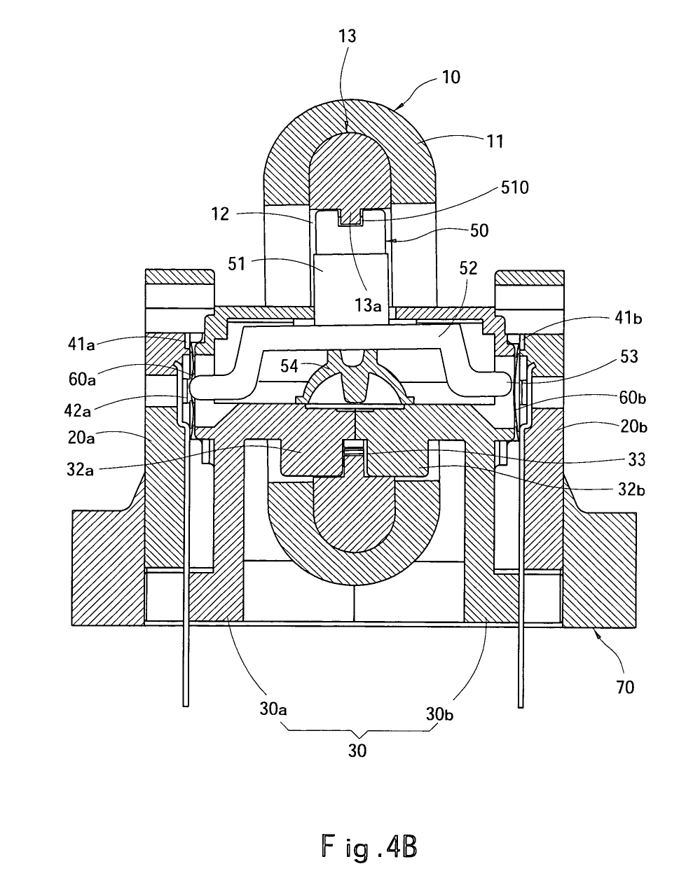

When the embodiment set forth above is in use, referring to FIGS. 4A and 4B, in normal conditions, the first conductive elements 60a and 60b are positioned on the first legs 41a and 41b, and the flat peripheral rim 61 is in contact with the first legs 41a and 41b. The bulged portion 62 is in contact with the lug 53 (as shown in FIG. 4A). When the hand-control unit 10 is moved leftwards by a user's hand, the controller 50 coupled with the hand-control unit 10 also is moved leftwards. The lug 53 is driven to press and dent the bulged portion 62 of the first conductive element 60a to contact the second leg 42a, hence, the first leg 41a and the second leg 42a form an electric connection to generate an instruction to move the screen picture leftwards. The pressing on first conductive element 60a also generates a compression feeling on user's hand (referring to FIG. 4B). Similarly, when the hand-control unit 10 is moved rightwards by the user's hand, the controller 50 is moved rightwards. The lug 53 presses and dents the bulged portion 62 of the first conductive element 60b to contact the second leg 42b, hence, the first leg 41b and the second leg 42b form an electric connection to generate another instruction to move the screen picture rightwards.

The first conductive elements 60a and 60b may be formed in other shapes or switches besides the elastic dome-shaped blade as long as they can be compressed by the lugs 53 to form electric connection between the first legs 41a and 41b, and the second legs 42a and 42b.

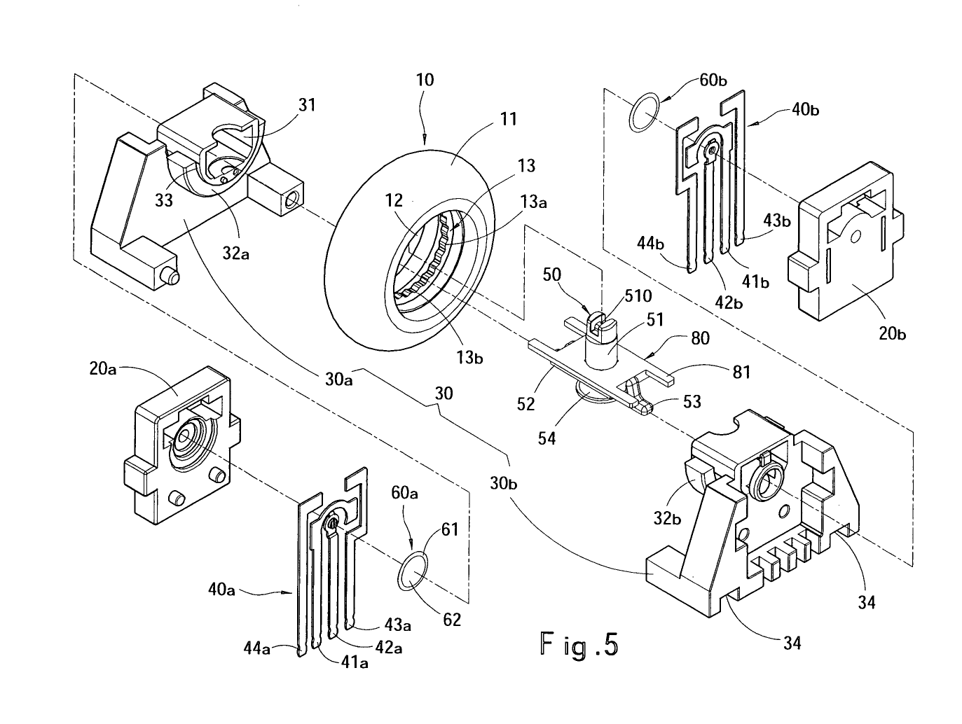

Referring to FIG. 5, the hand-control unit 10 can also generate forward and backward rolling and upward and downward movements. The base elements 30a and 30b have two detent portions 32a and 32b to define a trough 33 to serve as the rotation track of the hand-control unit 10. There are third legs 43a and 43b and fourth legs 44a and 44n on two sides of the first legs 41a and 41b, and second legs 42a and 42b. The bottom seat 52 of the controller 50 has a second conductive element 80 which is movable with the controller 50. The second conductive element 80 has four contact ends 81 extended outwards which do not connect to the legs 40a and 40b in the normal conditions. When the hand-control unit 10 is moved forwards and backwards by the user's hand, the guiding element 13a depresses the boss 510 to move the controller 50 forwards and backwards at the same time. Hence the third legs 43a and 43b, or the fourth legs 44a and 44b are connected electrically to generate instructions to scroll the screen picture longitudinally. Moreover, when the hand-control unit 10 is depressed, the second conductive element 80 is electrically connected to the first legs 41a and 41b on the two sides to generate a pressing instruction.

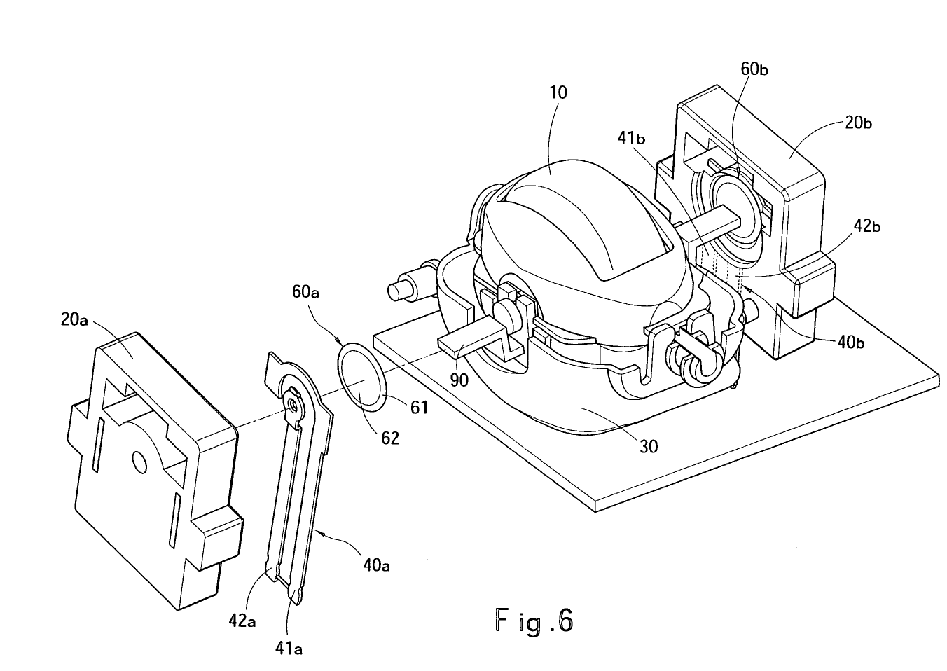

Refer to FIG. 6 for another embodiment of the invention. The basic structure is substantially same as the one previously discussed. Details of the structure and operation are omitted. In this embodiment, there are two contact arms 90 on two sides of the hand-control unit 10. The contact arms 90 are moved by the transverse movement of the hand-control unit 10 to compress the first conductive elements 60a and 60b, and electrically connect to the first legs 41a and 41b, and the second legs 42a and 42b to generate instructions to move the screen picture leftwards or rightwards.

To those skilled in the art, the concept of using the anchor members 20a and 20b to hold the leg couplers 40a and 40b can be adapted to other devices and applications that rely the transverse movement of the hand-control unit 10 to output instruction signals, and electrical connecting of the leg couplers 40a and 40b through the first conductive elements 60a and 60b to transmit different instructions. The aforesaid embodiments serve merely illustrative purpose, and are not the limitation of the invention. The invention has a simpler structure and can reduce cost. The size also is smaller and can make electronic devices more compact.

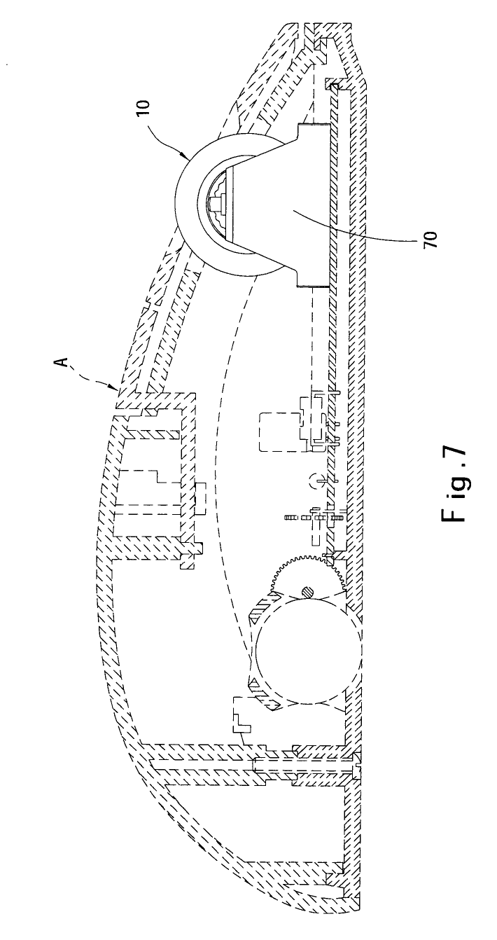

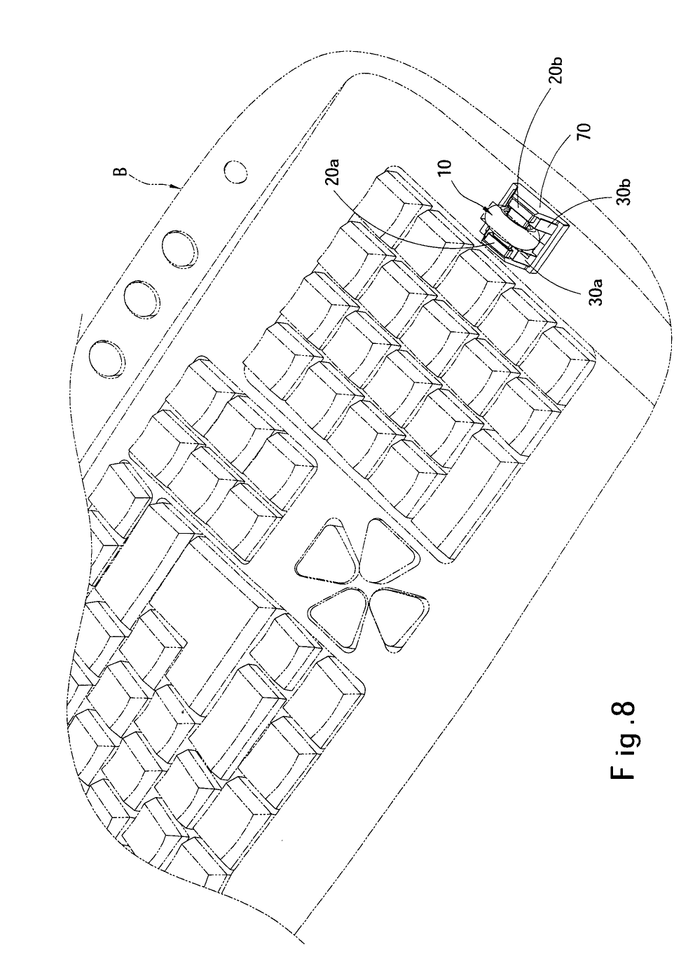

The first embodiment set forth above can be adopted on many types of electronic devices, such as a mouse device A (referring to FIG. 7), a keyboard B (referring to FIG. 8) or other remote controllers (not shown in the drawings) to output different instruction signals.

In short, the multi-instruction transverse input device according to the invention mainly includes the hand-control unit 10 and anchor members 20a and 20b on two sides of the hand-control unit 10 that contain leg couplers 40a and 40b. When the hand-control unit 10 is moved transversely, an instruction to move the screen picture transversely is generated, and user's hand can sense the movement. The structure is smaller and can make the product more compact. Fabrication and assembly are easier, and operation is simpler.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A multi-instruction transverse input device, comprising:
a hand-control unit being mounted onto a base and movable transversely; and
two anchor members located on two sides of the hand-control unit each having a leg coupler which contains a plurality of legs, the leg coupler and the hand-control unit being interposed by a first conductive element which is pressed by the transverse moving hand-control unit to form an electric connection on the leg coupler to generate an instruction signal for moving leftwards or rightwards.

2. The multi-instruction transverse input device of claim 1, wherein the hand-control unit has an exterior portion to receive a force to move the hand-control unit and a hollow mounting portion which has a guiding portion moving synchronously with the exterior portion, the base having a controller located in the hollow mounting portion to be driven by the guiding portion to generate a movement corresponding to the transverse movement of the hand-control unit.

3. The multi-instruction transverse input device of claim 2, wherein the controller includes a bottom seat, a moving rod located on the bottom seat, and a first elastic element beneath the bottom seat to anchor the bottom seat on the base, the moving rod having a boss on an upper side, the guiding portion having a plurality of consecutive guiding elements and guiding notches that are spaced from one another alternately, the boss being latched on one of the guiding notches in normal conditions.

4. The multi-instruction transverse input device of claim 3, wherein the bottom seat has two lugs extended from two sides thereof, the lugs compressing the first conductive element when the hand-control unit is moved transversely.

5. The multi-instruction transverse input device of claim 1, wherein the leg coupler includes a first leg and a second leg.

6. The multi-instruction transverse input device of claim 5, wherein the first conductive element connects to the first leg in the normal conditions, the first conductive element being connected electrically and respectively to the first leg and the second leg when the hand-control unit is moved leftwards and rightwards in an inclined manner.

7. The multi-instruction transverse input device of claim 6, wherein the first conductive element is an elastic dome-shaped blade which has a flat peripheral rim and a bulged portion in the center, the flat peripheral rim being connected to the first leg in the normal conditions, the bulged portion being connected to the second leg.

8. The multi-instruction transverse input device of claim 1 further having two contact arms on the two sides of the hand-control unit, the contact arms being movable with the transverse movement of the hand-control unit to compress the first conductive element.
